(19) United States
(12) Patent Application Publication
(10) Pub. No.: US 2008/0127666 A1
(43) Pub. Date: Jun. 5, 2008

(54) Vehicle Heat Exchanger and Cooling System

(75) Inventors: Gregory A. Major, Farmington Hills, MI (US); William R. Hill, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/566,325

(22) Filed: Dec. 4, 2006

(51) Int. Cl. B60H 1/32; F25B 13/00; F25D 17/02

(52) U.S. Cl. 62/244; 62/434; 62/324.4

(57) ABSTRACT

A cooling system for a vehicle and method of operating it is disclosed. The cooling system may include a refrigerant to liquid heat exchanger, which may be located outside of a passenger cabin, and a chiller, which may be located inside the passenger cabin. A refrigerant circuit and a water circuit may both engage the refrigerant to liquid heat exchanger. The refrigerant to liquid heat exchanger may be an integrated heat exchanger and expansion device.

### BACKGROUND OF THE INVENTION

The present application relates generally to a cooling system for a vehicle, and may include an integrated heat exchanger and expansion device.

Many automotive vehicles include heating, ventilation and air conditioning (HVAC) systems having an air-conditioning portion to provide cooling to the vehicle's occupants in the cabin of the vehicle. Such a system typically includes a refrigerant compressor that feeds refrigerant into a condenser, where heat is extracted from the refrigerant, an expansion valve for reducing the pressure (and hence temperature) of the refrigerant, and an evaporator that is employed in a HVAC module in the vehicle cabin to cool the air in the cabin. In some larger vehicles, such as vans, pickup trucks, and sport utility vehicles, an additional rear HVAC unit, including an additional evaporator and other components, is employed to enhance the cooling effects in the rear portion of the cabin.

For conventional vehicle air-conditioning systems, there is a desire to provide systems that may be lower cost, more environmentally friendly, more efficient, improve operational characteristics, and improve packaging flexibility. A possible limitation on some improvements, however, may be due to the fact that the refrigerant in the conventional air-conditioning system enters the passenger cabin. This may limit alternative types of refrigerant that may otherwise be considered for the vehicle air conditioning system. This may also restrict the packaging flexibility and increase the cost of employing multiple evaporators since refrigerant lines must be run to and from each evaporator in the passenger cabin. Moreover, undesirable noises produced by various components of the refrigeration system may also be transmitted into or generated in the passenger cabin via the system.

Thus, it is desirable to provide an HVAC system that improves on some or all of the drawbacks for the air conditioning portion of conventional HVAC systems used in vehicles.

### SUMMARY OF THE INVENTION

An embodiment contemplates a HVAC system for a vehicle having a passenger cabin. The HVAC system may have a refrigerant circuit and a water circuit. The refrigerant circuit may be located outside of the passenger cabin and include a compressor, condenser, expansion device, and a refrigerant to liquid heat exchanger, with the compressor operatively engaged between the condenser and the refrigerant to liquid heat exchanger and the expansion device operatively engaged between the condenser and the refrigerant to liquid heat exchanger. The water circuit may include a water pump, a chiller, located within the passenger cabin, and the refrigerant to liquid heat exchanger, with the water pump operatively engaging the chiller and the refrigerant to liquid heat exchanger to selectively cause a flow of water therethrough.

An embodiment contemplates an integrated evaporator and expansion device assembly for use in a HVAC system of a vehicle having a passenger cabin. The integrated evaporator and expansion device assembly may include a refrigerant to liquid heat exchanger core, a refrigerant inlet and a refrigerant outlet operatively engaging the refrigerant to liquid heat exchanger core to direct refrigerant therethrough, a water inlet and a water outlet operatively engaging the refrigerant to liquid heat exchanger core to direct water therethrough, and an expansion device connected to and operatively engaging the refrigerant inlet.

An embodiment contemplates a method of operating a HVAC system for a vehicle having a passenger cabin, the method comprising the steps of: compressing refrigerant in a compressor; removing heat from the refrigerant in a condenser; directing the refrigerant through an expansion device to reduce the temperature of the refrigerant; directing the refrigerant through a refrigerant to liquid heat exchanger located outside of the passenger cabin; pumping water through the refrigerant to liquid heat exchanger to cause a heat exchange between the water and the refrigerant; and directing the water through a chiller located inside the passenger cabin.

An advantage of an embodiment is the integration of a refrigerant to liquid evaporator with an expansion device that may allow for enhanced packaging and improved system performance. With the integrated evaporator and expansion device located outside of the passenger cabin, flow noise that may emanate from an integrated expansion valve or orifice tube is isolated from the passenger cabin. Moreover, any compressor working noise transmitted in the refrigerant lines may be isolated from the passenger cabin as well.

An advantage of an embodiment is that, since the refrigerant does not need to enter the passenger cabin, alternative refrigerants (which may be less desirable to employ when the refrigerant enters a passenger cabin) may be considered for the refrigerant loop of the air conditioning system.

An advantage of an embodiment, for a vehicle with two or more HVAC modules in the passenger cabin, may be reduced costs for the overall system. The charge of refrigerant may be less than a comparable conventional air-conditioning system since the same refrigerant loop can be used for vehicles with one or multiple cooling points (HVAC modules). Moreover, this may eliminate any issues with proper refrigerant charge that can occur when differing numbers of conventional evaporators are in operation, and reduce potential issues for oil trapping for HVAC systems with the front unit operating and the rear unit turned off. In addition, even for a vehicle with only one HVAC module, the total refrigerant charge may be reduced.

An advantage of an embodiment may be improved packaging and design flexibility in that the location and number of cooling points is simplified when chillers—using water to cool the air—are employed in each HVAC module in the passenger cabin. Employing chillers with water cooling for cooling the air in the passenger cabin may also provide a more uniform temperature in the liquid to air heat exchangers than conventional evaporators employing refrigerant to cool the air, which can be subject to temperature variations due to phase separation, mal-distribution of refrigerant, or cold spots where frosting or ice formation has started. Moreover, chillers may be made of copper and brass, which may help reduce odor concerns since bacteria and fungus are less likely to develop on copper and brass than on the aluminum used in conventional evaporators with refrigerant flowing through them.

An advantage of an embodiment may be a potential to operate the integrated evaporator and expansion device assembly below freezing in order to allow for a faster cooling of the passenger cabin. It may also be possible to provide for a cold storage function for vehicles waiting at stop lights or when parked for short times without the compressor operating.

### BRIEF DESCRIPTION OF THE DRAWINGS

FIG. 1 is a schematic diagram of a heating ventilation and air conditioning system for a vehicle according to a first embodiment.

FIG. 2 is a schematic diagram of an integrated evaporator and expansion device as employed in the system of FIG. 1.

FIG. 3 is a schematic diagram of a heating ventilation and air conditioning system for a vehicle according to a second embodiment.

FIG. 4 is a schematic diagram of an integrated evaporator and expansion device according to a third embodiment.

FIG. 5 is a section cut taken along line 5-5 in FIG. 4.

FIG. 6 is a schematic diagram of an integrated evaporator and expansion device according to a fourth embodiment.

FIG. 7 is a schematic diagram of an integrated evaporator and expansion device according to a fifth embodiment.

FIG. 8 is a schematic diagram of an integrated evaporator and expansion device according to a sixth embodiment.

FIG. 9 is a schematic diagram of an integrated evaporator and expansion device according to a seventh embodiment.

### DETAILED DESCRIPTION

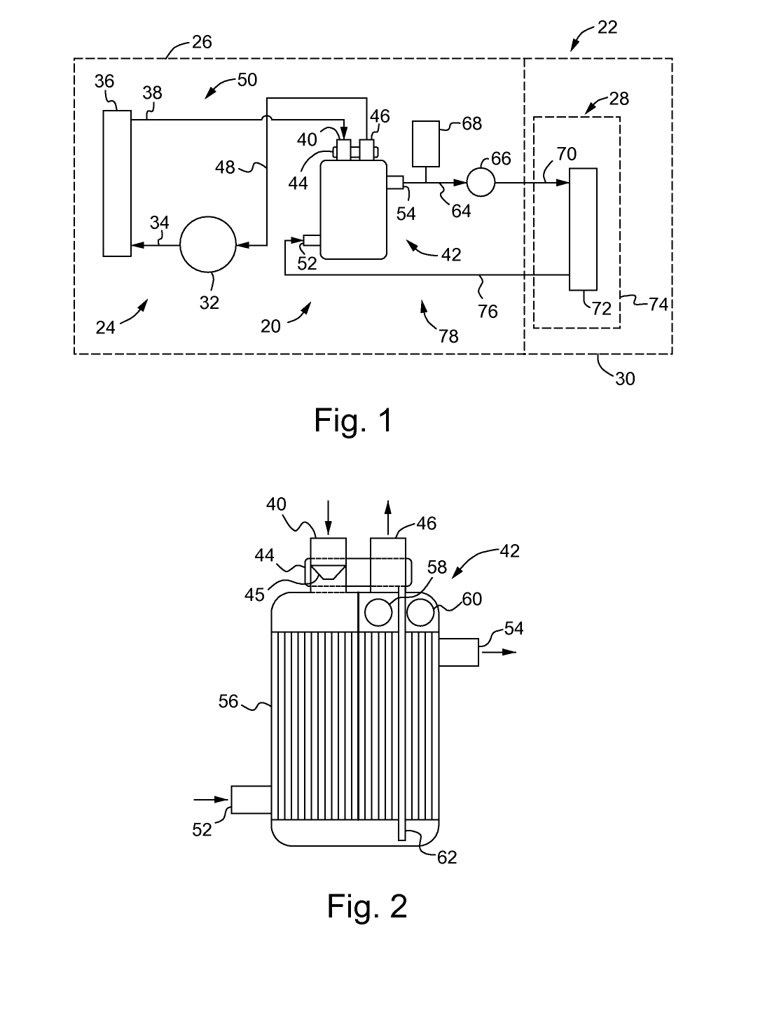

FIGS. 1-2 illustrate a heating, ventilation and air conditioning (HVAC) system 20 for a vehicle 22, according to a first embodiment. The HVAC system 20 includes a first portion 24, located in an engine compartment 26 of the vehicle 22, and a second portion 28, located in a cabin 30 (also called a passenger compartment) of the vehicle 22. The first portion 24 includes a refrigerant compressor 32 connected by a refrigerant line 34 to a condenser 36, which, in turn, is connected, via a refrigerant line 38, to a refrigerant inlet 40 of an integrated evaporator and expansion device assembly 42. The refrigerant inlet 40 includes an expansion device, such as a thermostatic expansion valve 44. The thermostatic expansion valve 44 has a variable orifice 45 that controls the amount of refrigerant flowing into the integrated assembly 42. The orifice may be controlled by the pressure and temperature of the refrigerant at a refrigerant outlet 46 of the integrated assembly 42. A refrigerant line 48 connects the refrigerant outlet 46 to the refrigerant compressor 32, completing a refrigerant circuit 50 (a primary loop).

The expansion valve 44, being integrated into the integrated assembly 42, reduces the number of separate components in the refrigerant circuit 50 relative to a conventional refrigeration circuit where an evaporator in the passenger cabin is separate from an expansion valve in an engine compartment, with the two connected by a refrigerant line. This integration of multiple components may provide enhanced packaging and performance, and also may reduce the number of separate components that need to be assembled into the vehicle 22 since the expansion valve 44 is now a single unit with a heat exchanger (discussed below).

The integrated assembly 42 also includes a water inlet 52 and a water outlet 54. When the term water is used herein, it also includes a coolant mixture, such as water and glycol (commonly called antifreeze), or other suitable liquid. The water flows from the water inlet 52 to the water outlet 54 through a refrigerant-to-liquid heat exchanger core 56. The refrigerant also flows through the core 56—from the refrigerant inlet 40 to the refrigerant outlet 46—in close proximity to the water in order to facilitate the absorption of heat from the water by the refrigerant. The integrated assembly 42 may also include a charge port 58, a suction pressure sensor 60 and an oil pickup tube 62.

One will note that the entire refrigerant circuit 50, unlike a conventional vehicle refrigerant circuit, may be located completely outside of the cabin 30. This may allow for the use of different types of refrigerants—which would otherwise not be considered suitable in a conventional HVAC system where the refrigerant circuit is partially inside the cabin—since the entire refrigerant circuit 50 is located outside of the cabin 30. Such alternative refrigerants may be more cost effective, allow for more efficient air conditioning, be more environmentally friendly, etc. Moreover, with the entire refrigerant circuit 50 located outside of the cabin 30, the integrated assembly 42 may be able to mount closer to the condenser 36 and compressor 32, thus reducing the length of the refrigerant lines, (as opposed to a conventional system). This may not only reduce the amount of refrigerant needed, but also reduce the likelihood of refrigerant and oil accumulating in refrigerant lines, (as opposed to a conventional system).

A water line 64 leads from the water outlet 54 to a water pump 66, and may have an expansion tank 68 connected thereto. The water pump 66 connects, via another water line 70, to a chiller 72, which is located in a HVAC module 74 in the cabin 30. The chiller 72, then, performs the function of a conventional evaporator in a HVAC module of a vehicle—taking heat and humidity out of air that flows through it before the air enters the cabin 30. Another water line 76 directs the water from the chiller 72 to the water inlet 52 of the integrated assembly 42, completing a water circuit 78 (secondary loop). One will note that this water circuit 78 is partially within the cabin 30 and partially outside the cabin 30.

Copper or brass heat exchangers may be used instead of aluminum (commonly used in vehicle evaporators) for the chiller 72. A copper or brass chiller 72 is not mandatory with this concept, aluminum can be used, but copper or brass has the advantage that organic material (bacteria or fungus) is less likely to grow on it than on aluminum, thus reducing the potential for the chiller 72 to produce undesirable odors in the air flowing into the cabin 30.

The operation of the HVAC system 20 and integrated evaporator and expansion valve assembly 42 will now be described. The arrows in the refrigerant circuit 50 and water circuit 78 in FIGS. 1 and 2 indicate the direction of refrigerant flow and water flow, respectively. When air-conditioning is desired, the refrigerant compressor 32 and water pump 66 are activated. The refrigerant is compressed in the compressor 32 and flows through the condenser 36, where it is cooled, and then flows to the expansion valve 44 in the refrigerant inlet 40 of the integrated assembly 42. The expansion valve 44 is adjusted based on the measured temperature and pressure of the refrigerant at the refrigerant outlet 46. The refrigerant temperature drops as it flows through the expansion valve 44, then it flows into the heat exchanger core 56. As the refrigerant flows through the core 56, it absorbs heat from the water flowing through the core 56. The refrigerant then flows from the integrated assembly 42 back to the refrigerant compressor 32, completing the refrigerant circuit 50.

The water pump 66 sends the water through the chiller 72 and into the heat exchanger core 56 through the water inlet 52. As mentioned above, heat is absorbed from the water by the refrigerant in the core 56. The water then flows from the water outlet 54 back to the water pump 66, to complete the water circuit 78. The expansion tank 68 is also provided in the water circuit 78 in order to allow for thermal expansion and contraction of the water. When a blower (not shown) in the front HVAC module 74 blows air through the chiller 72, the water in the chiller 72 absorbs heat from the air, cooling it prior to flowing from vents (not shown) in the cabin 30.

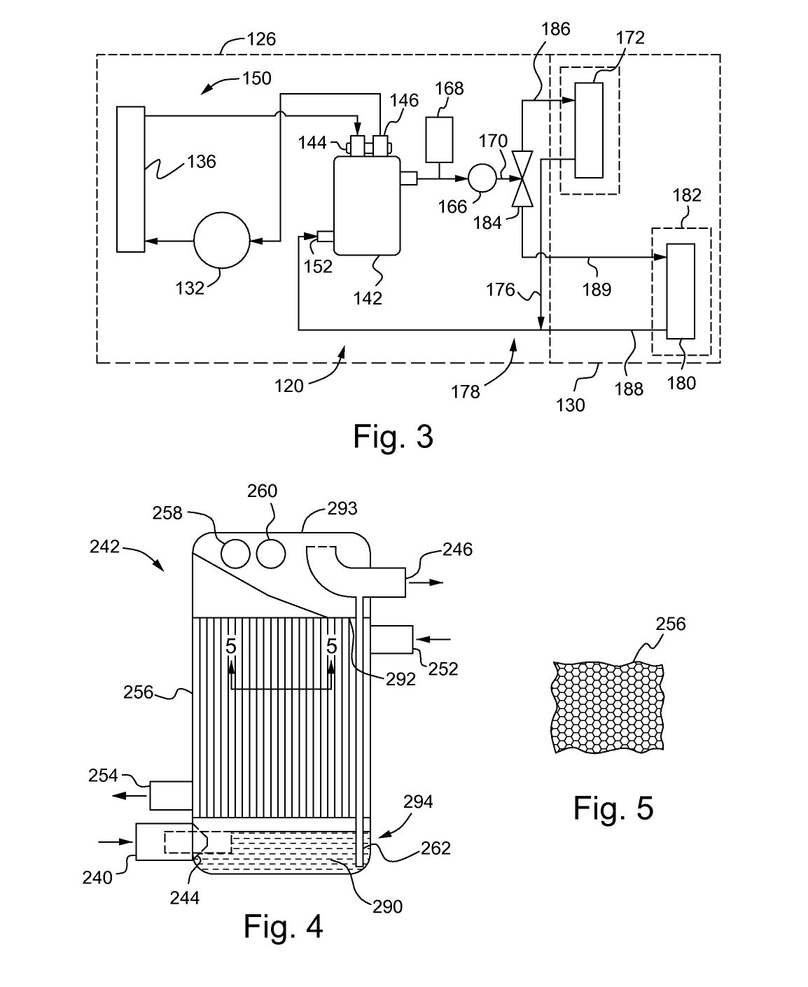

FIG. 3 illustrates a heating, ventilation and air conditioning (HVAC) system for a vehicle according to a second embodiment. The arrangement described in FIG. 2 has many items in common with that of FIG. 1 and to avoid unnecessary repetition of the description, the same reference numerals have been used but falling within the 100-series. The significant difference with this embodiment is the addition of a rear chiller 180 in a rear HVAC module 182. The water flowing from the water pump 166 through water line 170 may enter an optional, adjustable valve 184 that has two outlets, with the first waterline 186 leading from a first outlet to the chiller 172 and a second waterline 189 leading from a second outlet to the rear chiller 180. Water lines 176 and 188 extend from the chiller 172 and rear chiller 180, respectively, to the water inlet 152 of the integrated assembly 142.

The operation of the HVAC system 120 of the embodiment in FIG. 3 is similar to that in FIG. 1. Since the refrigerant circuit 150 is entirely outside the cabin 130, the addition of a rear HVAC module 182 and rear chiller 180 does not affect it. Thus, the refrigerant circuit 150 may operate the same as in the first embodiment. The water flow and heat exchange that occurs in the integrated assembly 142, as well as the water pump and expansion tank operation, may also be the same as in the first embodiment. The significant change is with the water flow to and from the chillers 172, 180. The adjustable valve 184 will direct a portion of the water from the water pump 166 to the chiller 172 and another portion of the water to the rear chiller 180. The particular proportions will depend upon the cooling demands requested by the HVAC module 174 and the rear HVAC module 182. Alternatively, the adjustable valve 184 may be eliminated from the system and the proportion of water flow to each of the HVAC modules 174, 182 predetermined.

As with the first embodiment, the cooling of the cabin 130 is accomplished without requiring refrigerant to flow anywhere within the cabin 130. This provides design flexibility in locating the HVAC modules 174, 182 where desired to provide optimum packaging or cooling of the vehicle cabin 130. Moreover, while the first two embodiments show a single cooling point and two cooling points, respectively, additional cooling points may be added relatively easily since only cooled water would be transferred to these additional HVAC modules rather than refrigerant. In addition, for the second embodiment, there may be a cost reduction for the overall system since the charge of refrigerant is likely much less than that required for a comparable conventional system having two separate evaporators in the cabin. The same is true for a system that would have three or more chillers as well. And, for all these systems, the refrigerant circuit 150 may remain essentially unchanged, reducing the cost of the refrigerant side of the system for vehicles having an option of only one, or two or more cooling points in the cabin 130, and allowing for the evaporator and expansion valve to remain an integrated assembly 142.

FIGS. 4 and 5 illustrate an integrated evaporator and expansion device assembly 242 according to a third embodiment. The arrangement described in FIGS. 4 and 5 has many items in common with that of FIG. 2 and to avoid unnecessary repetition of the description, the same reference numerals have been used but falling within the 200-series. The refrigerant to liquid heat exchanger core 256 includes some core elements carrying refrigerant from the refrigerant inlet 240 to the refrigerant outlet 246, and the other core elements carrying the water from the water inlet 252 to the water outlet 254. Generally, in this embodiment, the flow is vertical through the core 256. Also, in this embodiment, instead of an expansion valve, a porous orifice tube 244 is integrated into the refrigerant inlet 240. An oil pickup tube 262 extends from near the refrigerant outlet 246 down into liquid refrigerant 290 that settles in the bottom of the integrated evaporator and expansion device assembly 242. This integrated assembly 242 may also include a charge port 258, a suction pressure sensor 260, and an orifice 292 used to drain refrigerant from an upper separation chamber 293. The upper separation chamber 293 defines a secondary vapor/liquid separator. Thus, this integrated assembly 242 also integrates an accumulator 294 therein.

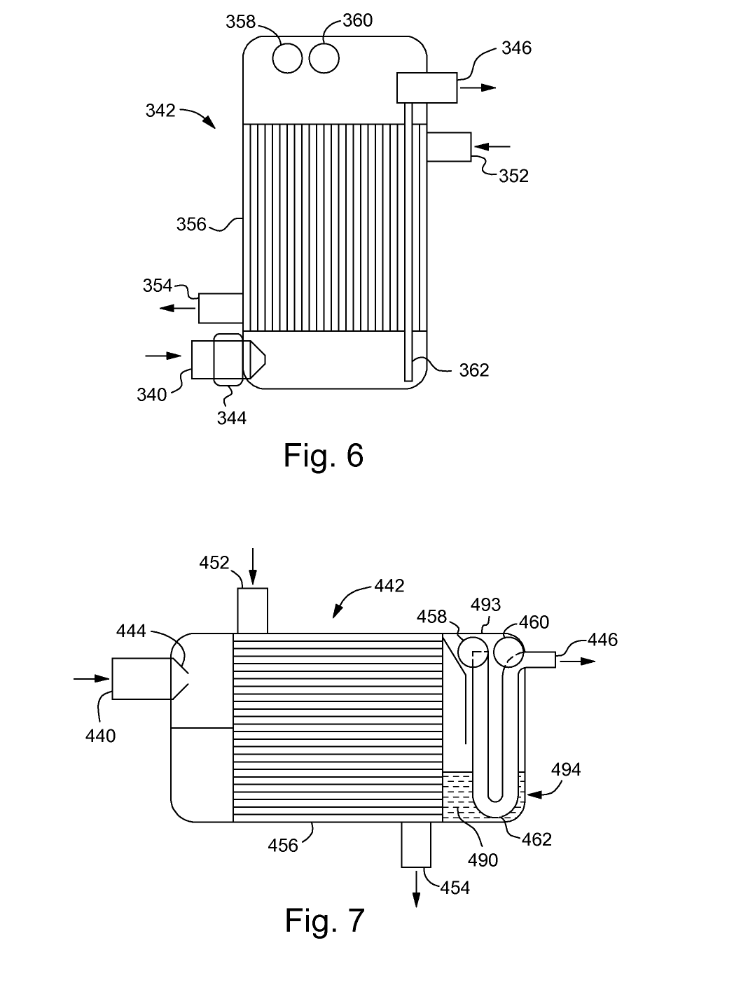

FIG. 6 illustrates an integrated evaporator and expansion device assembly 342 according to a fourth embodiment. The arrangement described in FIG. 6 has many items in common with that of FIGS. 2 and 4, and to avoid unnecessary repetition of the description, the same reference numerals have been used but falling within the 300-series. The refrigerant inlet and outlet 340, 346, and the water inlet and outlet 352, 354, as well as the core 356 are arranged similar to the integrated assembly in FIG. 4. The expansion device 344, rather than being an orifice tube as shown in the embodiment of FIG. 4, it is an expansion valve 344 similar to that shown in FIG. 2.

FIG. 7 illustrates an integrated evaporator and expansion device assembly 442 according to a fifth embodiment. The arrangement described in FIG. 7 has many items in common with that of FIGS. 2, 4 and 6, and to avoid unnecessary repetition of the description, the same reference numerals have been used but falling within the 400-series. This is a tube and shell type of arrangement, with the refrigerant and water flowing horizontally through the heat exchanger core 456. The expansion device 444 is an orifice tube integrated into the refrigerant inlet 440 of the integrated assembly 442. This integrated assembly 442 also integrates an accumulator 494 therein, including an upper separation chamber 393. An oil pickup 462 is located on the tube leading to the refrigerant outlet 446.

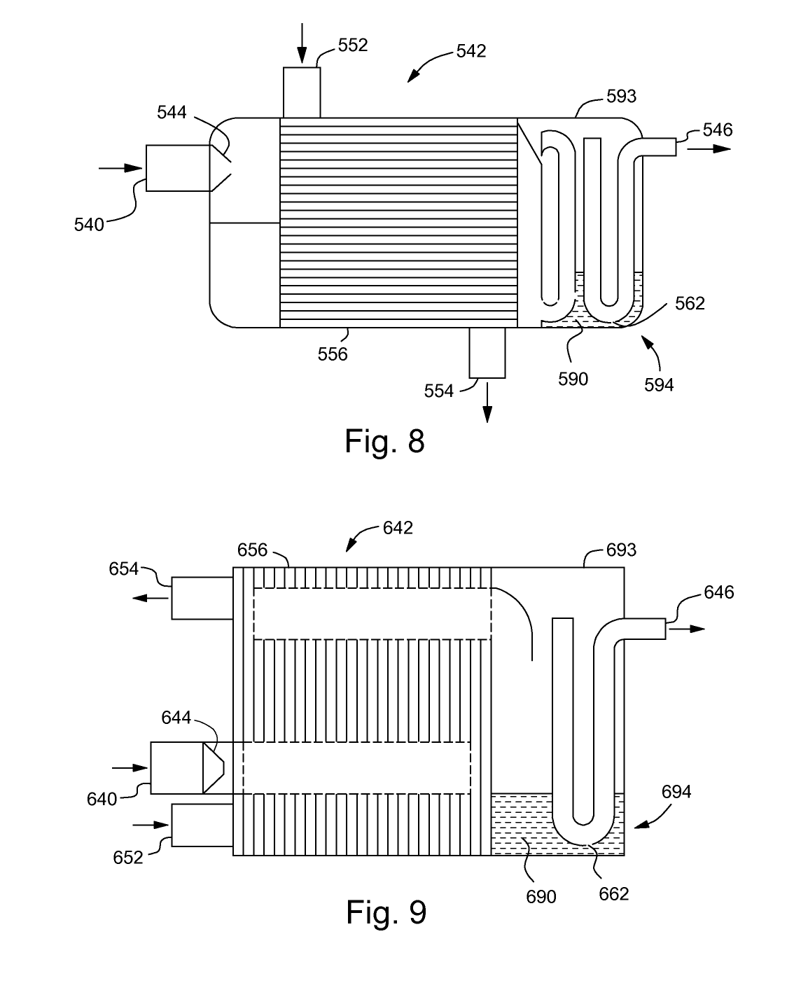

FIG. 8 illustrates an integrated evaporator and expansion device assembly 542 according to a sixth embodiment. The arrangement described in FIG. 8 has many items in common with that of FIGS. 2, 4, 6 and 7, and to avoid unnecessary repetition of the description, the same reference numerals have been used but falling within the 500-series. This is again a tube and shell type of arrangement, similar to FIG. 7, with the refrigerant and water flowing horizontally through the heat exchanger core 556, an orifice tube for the expansion device 544 integrated into the refrigerant inlet 540, and an integrated accumulator 594. The embodiment of FIG. 8 is distinguishable from the embodiment of FIG. 7 in that the accumulator 594 has a different type of configuration.

FIG. 9 illustrates an integrated evaporator and expansion device assembly 642 according to a seventh embodiment. The arrangement described in FIG. 9 has many items in common with that of FIGS. 2, 4, and 6-8, and to avoid unnecessary repetition of the description, the same reference numerals have been used but falling within the 600-series. This is a vertical plate type of arrangement for the heat exchanger core 656. An expansion valve 644 is integrated into the refrigerant inlet 640. An accumulator 694 is integrated into the integrated assembly 642, with an upper separation chamber 693. An oil pickup 662 is located in a tube leading to the refrigerant outlet 646.

Any of the embodiments of the integrated evaporator and expansion device assemblies illustrated in FIGS. 4-9 may be employed with the HVAC systems 20, 120 illustrated in FIGS. 1 and 3. All of these embodiments allow for the integration of an evaporator—for heat exchange between the refrigerant and water—and an expansion device, whether it be an expansion valve or an orifice tube. Moreover, some of these embodiments also allow for the integration of an accumulator into the integrated assembly, further reducing the number of separate components in the particular HVAC system. In addition, all of the embodiments disclosed allow for the refrigeration circuit to be entirely outside of the cabin of the vehicle.

While certain embodiments of the present invention have been described in detail, those familiar with the art to which this invention relates will recognize various alternative designs and embodiments for practicing the invention as defined by the following claims.

What is claimed is:

1. A HVAC system for a vehicle having a passenger cabin, the HVAC system comprising:
a refrigerant circuit located outside of the passenger cabin and including a compressor, a condenser, an expansion device, and a refrigerant to liquid heat exchanger, with the compressor operatively engaged between the condenser and the refrigerant to liquid heat exchanger and the expansion device operatively engaged between the condenser and the refrigerant to liquid heat exchanger; and
a water circuit including a water pump, a chiller located within the passenger cabin, and the refrigerant to liquid heat exchanger, with the water pump operatively engaging the chiller and the refrigerant to liquid heat exchanger to selectively cause a flow of water therethrough.

2. The HVAC system of claim 1 wherein the water circuit includes a second chiller operatively engaging the water pump to selectively receive the flow of water therethrough.

3. The HVAC system of claim 2 wherein the water circuit includes an adjustable valve located between the water pump and the chiller and the second chiller and operative to selectively vary a proportion of the flow of water to the chiller and the second chiller.

4. The HVAC system of claim 1 wherein the water circuit includes an expansion tank operative to receive and discharge the water therefrom in response to thermal expansion and contraction of the water.

5. The HVAC system of claim 1 wherein the expansion device is integral with the refrigerant to liquid heat exchanger, defining an integrated evaporator and expansion device assembly.

6. The HVAC system of claim 5 wherein the integrated evaporator and expansion device assembly includes an accumulator that is integral therewith.

7. The HVAC system of claim 5 wherein the expansion device is a thermostatic expansion valve.

8. The HVAC system of claim 5 wherein the expansion device is an orifice tube.

9. An integrated evaporator and expansion device assembly for use in a HVAC system of a vehicle having a passenger cabin, the integrated evaporator and expansion device assembly comprising:
a refrigerant to liquid heat exchanger core;
a refrigerant inlet and a refrigerant outlet operatively engaging the refrigerant to liquid heat exchanger core to direct refrigerant therethrough;
a water inlet and a water outlet operatively engaging the refrigerant to liquid heat exchanger core to direct water therethrough; and
an expansion device connected to and operatively engaging the refrigerant inlet.

10. The integrated evaporator and expansion device assembly of claim 9 including an integral accumulator located adjacent to the refrigerant outlet.

11. The integrated evaporator and expansion device assembly of claim 9 wherein the refrigerant to liquid heat exchanger core and the expansion device are located outside of the passenger cabin.

12. The integrated evaporator and expansion device assembly of claim 9 wherein the refrigerant to liquid heat exchanger core is oriented for a vertically oriented flow of the refrigerant and the water therethrough.

13. The integrated evaporator and expansion device assembly of claim 9 wherein the refrigerant to liquid heat exchanger core is oriented for a horizontally oriented flow of the refrigerant and the water therethrough.

14. The integrated evaporator and expansion device assembly of claim 9 including an integral oil pickup operatively engaging the refrigerant outlet.

15. The integrated evaporator and expansion device assembly of claim 9 wherein the expansion device is a thermostatic expansion valve.

16. The integrated evaporator and expansion device assembly of claim 9 wherein the expansion device is an orifice tube.

17. The integrated evaporator and expansion device assembly of claim 9 wherein the integrated evaporator and expansion device assembly defines a portion of a refrigerant circuit that is located outside of the passenger cabin.

18. A method of operating a HVAC system for a vehicle having a passenger cabin, the method comprising the steps of:
(a) compressing refrigerant in a compressor;
(b) removing heat from the refrigerant in a condenser;
(c) directing the refrigerant through an expansion device to reduce the temperature of the refrigerant;
(d) directing the refrigerant from the expansion device through a refrigerant to liquid heat exchanger located outside of the passenger cabin;
(e) pumping water through the refrigerant to liquid heat exchanger to cause a heat exchange between the water and the refrigerant; and
(f) directing the water through a chiller located inside the passenger cabin.

19. The method of claim 18 further including the step of (g) directing the water through a second chiller.

20. The method of claim 18 wherein steps (c) and (d) are further defined by the refrigerant being directed through an integrated assembly including the expansion device and the refrigerant to liquid heat exchanger.
